(19) United States
(12) Patent Application Publication
(10) Pub. No.: US 2025/0242481 A1
(43) Pub. Date: Jul. 31, 2025

(54) OIL FILTER-USED APPARATUS

(71) Applicant: U-CAR INDUSTRY CO., LTD., TAICHUNG (TW)

(72) Inventor: JUNG-HUA CHUANG, TAICHUNG (TW)

(21) Appl. No.: 18/427,750

(22) Filed: Jan. 30, 2024

(51) Int. Cl. B25B 27/00

(52) U.S. Cl. CPC B25B 27/0042

(57) ABSTRACT

An oil filter-used apparatus includes a cover and multiple collars in different sizes. The cover is used for engagement with an external torque tool and includes an annular wall. The multiple collars are used for engagement with oil filters in different size. One of the collars is selected for connecting one of the oil filters to the annular wall.

### BACKGROUND OF INVENTION

### 1. Field of Invention

The present invention relates to an oil filter of a vehicle and, more particularly, to an oil filter-used apparatus.

### 2. Related Prior Art

Oil is used to lubricate and cool some parts of a vehicle. A filter is used to filter the oil to prolong the life of the oil. A tool is used to detach the filter from the vehicle so that the oil can be drained from the vehicle. The tool used to attach a new filter to the vehicle after new oil is filled in the vehicle.

Taiwanese Patent No. 294200, a tool 30 is operable to rotate an oil filter 40 so that the oil filter is attached to or detached from a vehicle. The oil filter 40 is in the form of a canister. The tool 30 is in the form of a socket. The tool 30 includes a polygonal space 32 for receiving a polygonal section of the oil filter 40. The tool 30 includes a square bore 31 for receiving a square section of an Allen key. Thus, the tool 30 and the Allen key are operable to rotate the oil filter 40.

It can easily be understood that the size of the tool 30 is determined by that of the oil filter. Hence, multiple tools in different sizes are prepared for oil filters in different sizes. It costs a lot of money and takes a lot of space to have multiple such tools for such oil filters.

The present invention is therefore intended to obviate or at least alleviate the problems encountered in the prior art.

### SUMMARY OF INVENTION

It is the primary objective of the present invention to provide an inexpensive oil filter-used apparatus.

To achieve the foregoing objective, the oil filter-used apparatus includes a cover and multiple collars in different sizes. The cover is used for engagement with an external torque tool and includes an annular wall. The multiple collars are used for engagement with oil filters in different size. One of the collars is selected for connecting one of the oil filters to the annular wall.

Other objectives, advantages and features of the present invention will be apparent from the following description referring to the attached drawings.

### BRIEF DESCRIPTION OF DRAWINGS

The present invention will be described via detailed illustration of multiple embodiments referring to the drawings wherein:

FIG. 1 is an exploded view of an oil filter-used apparatus according to the first embodiment of the present invention;

FIG. 2 is a perspective view of a cover the oil filter-used apparatus shown in FIG. 1;

FIG. 3 is a side view of the cover shown in FIG. 1;

FIG. 4 is a bottom view of the cover shown in FIG. 3;

FIG. 5 is a top view of the cover shown in FIG. 3;

FIG. 6 is a cross-sectional view of the cover shown in FIG. 1;

FIG. 7 is a cross-sectional view of the cover taken along a line A-A shown in FIG. 6;

FIG. 8 is a cross-sectional view of a cover of an oil filter-used apparatus according to the second embodiment of the present invention;

FIG. 9 is a cross-sectional view of a cover of an oil filter-used apparatus according to the third embodiment of the present invention;

FIG. 10 is a side view of a socket wrench used with the oil filter-used apparatus shown in FIG. 6;

FIG. 11 is a cross-sectional view of an Allen key used with the oil filter-used apparatus shown in FIG. 6;

FIG. 12 is an exploded view of an oil filter-used apparatus according to the fourth embodiment of the present invention; and

FIG. 13 is a cross-sectional view of the cover shown in FIG. 12.

### DETAILED DESCRIPTION OF PREFERRED EMBODIMENTS

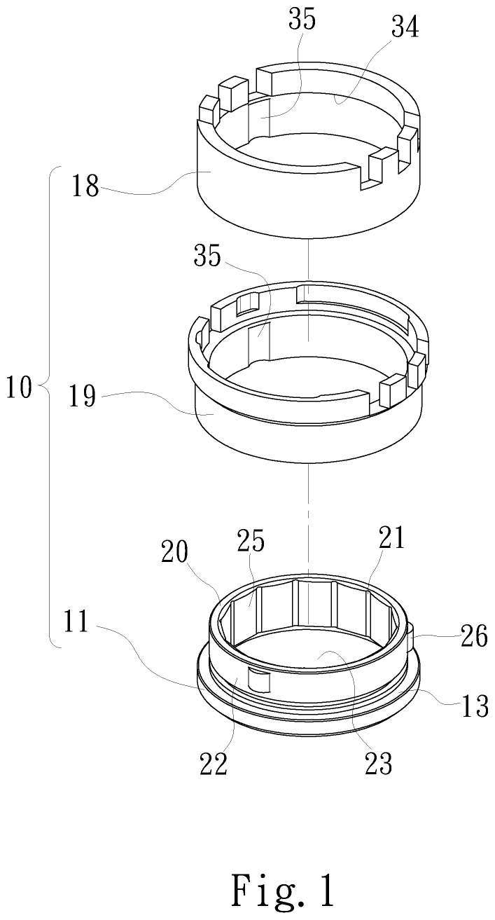

Referring to FIG. 1, an oil filter-used apparatus 10 includes a cover 11 and a set of collars according to a first embodiment of the present invention. The set includes multiple collars in different sizes such as two collars 18 and 19. In operation, the cover 11 is used with a collar selected from the set.

Referring to FIG. 3, the cover 11 is formed with two faces 12 and 13. In operation, the face 12 is a lower face and the face 13 is an upper face. The cover 11 includes a non-circular boss 14 extending from a center of the face 12 and an annular wall 20 extending from the face 13.

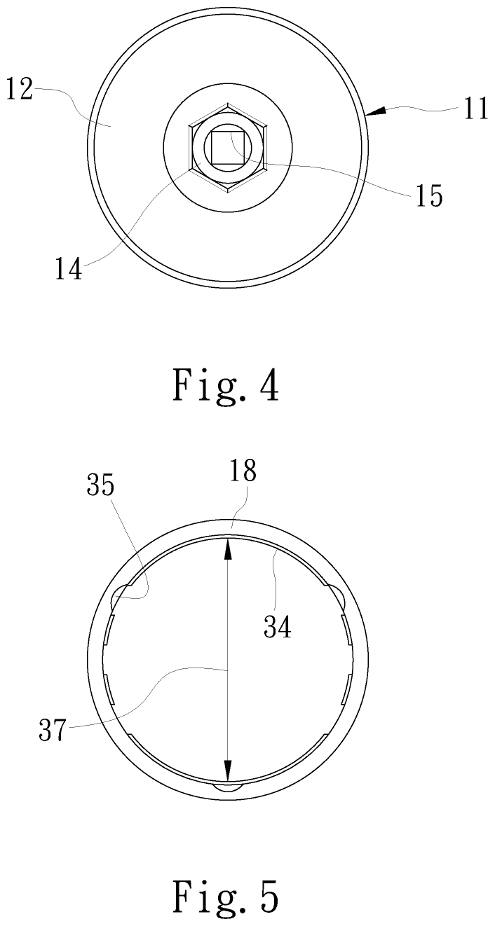

Referring to FIG. 4, the non-circular boss 14 is preferably a polygonal boss and more preferably a hexagonal boss. The non-circular boss 14 includes a non-circular bore 15 such as a square bore preferably.

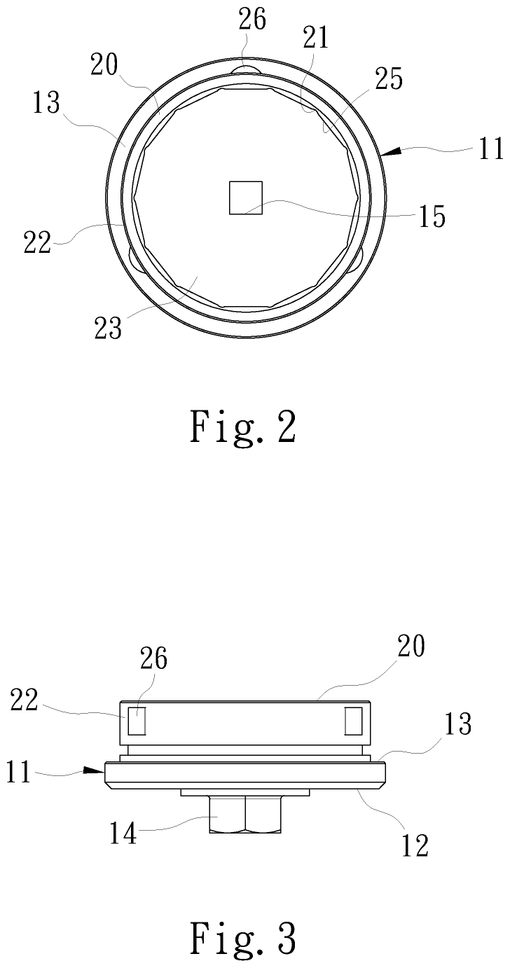

Referring to FIG. 2, the annular wall 20 includes an internal side 21 and an external side 22. The annular wall 20 preferably includes multiple bosses 26 such as three bosses 26 extending from the external side 22. However, the annular wall 20 can include only one boss 26 in another embodiment. The internal side 21 of the annular wall 20 is a polygonal side including multiple facets 25 extending around a space 23 in communication with the non-circular bore 15 (FIG. 7).

Referring to FIG. 5, each of the collars 18 and 19 includes an external side (not numbered) formed with a diameter. Each of the collars 18 and 19 includes an internal side (not numbered) formed with two different diameters 37, thereby providing an annular shoulder 34 that divides each of the collars 18 and 19 into two sections, one thinner than the other. The thinner section of each of the collars 18 and 19 is made with the recesses 35 corresponding to the bosses 26.

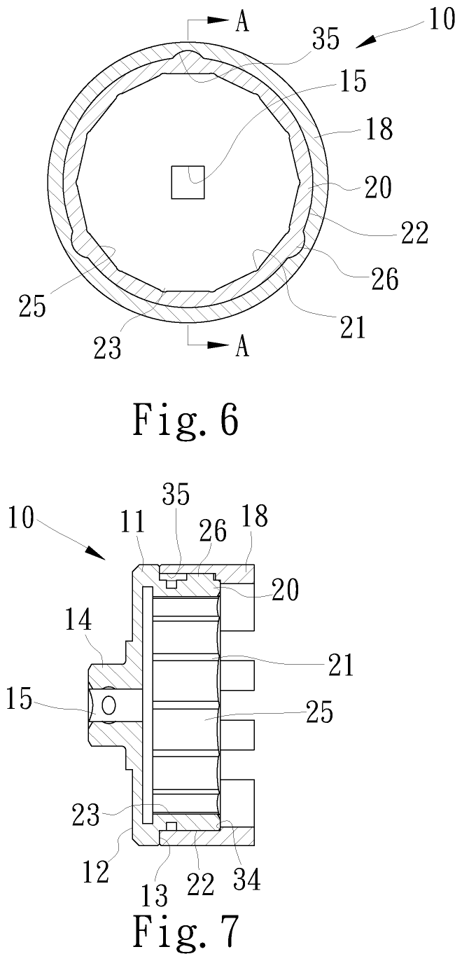

Referring to FIG. 6, the collar 18 extends around the annular wall 20, i.e., the annular wall 20 is inserted in the collar 18. Thus, the cover 11 and the collar 18 together form the oil filter-used apparatus 10. Now, the recesses 35 receive the bosses 26, i.e., the bosses 26 are located in the recesses 35. Thus, the cover 11 is not rotatable relative to the collar 18, i.e., the cover 11 is only rotatable together with the collar 18.

Referring to FIG. 7, an annular edge (not numbered) of the collar 18 is in contact with the face 13 of the cover 11. The annular wall 20 includes an annular edge (not numbered) in contact with the annular shoulder 34. The cover 11 includes an annular edge (not numbered) flush with the external side of the collar 18.

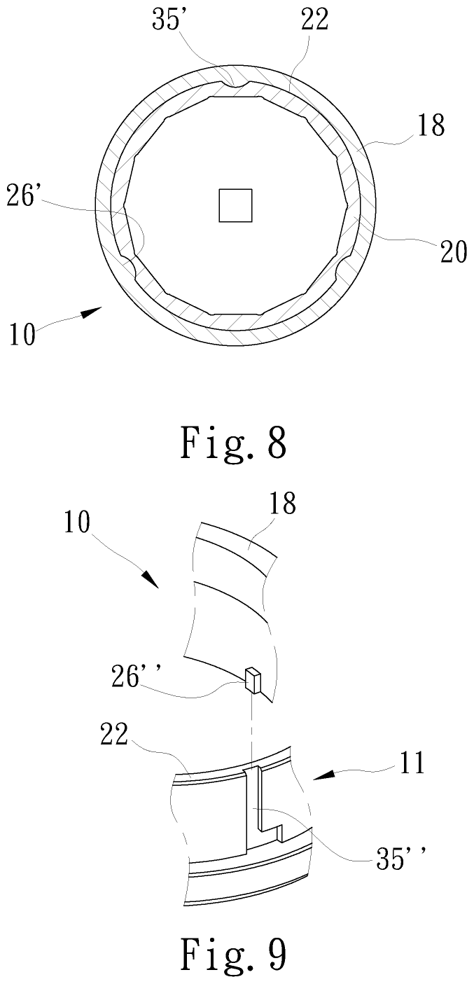

Referring to FIG. 8, according to a second embodiment of the present invention, the external side 22 of the annular wall 20 includes recesses 35′ for receiving formed on bosses 26′ formed on the collar 18 so that the cover 11 is rotatable together with the collar 18.

Referring to FIG. 9, according to a third embodiment of the present invention, the external side 22 of the annular wall 20 includes a L-shaped grooves 35″ for receiving bosses 26″ formed on the collar 18. Each of the L-shaped grooves 35 includes a longitudinal section (not numbered) in communication with a transverse section (not numbered) relative to the annular wall 20.

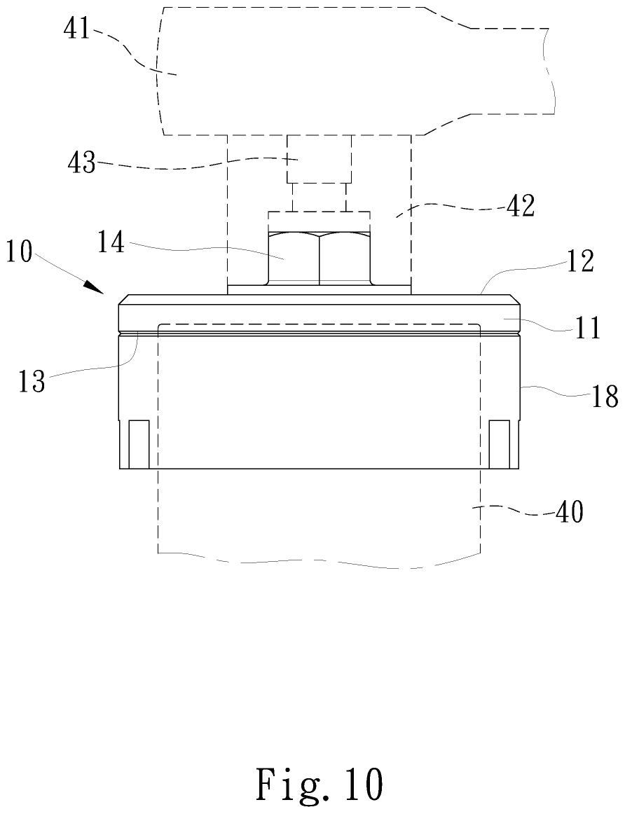

Referring to FIG. 10, in operation, the oil filter-used apparatus 10 receives an oil filter 40. The non-circular boss 14 is inserted in a non-circular bore (not numbered) made in a first side of a socket 42. A wrench 41 includes a tongue 43 located in a non-circular bore (not numbered) made in a second side of the socket 42. Thus, the wrench 41, the socket 42 and the oil filter-used apparatus 10 are used together to rotate the oil filter 40 relative to a vehicle. Thus, the oil filter 40 is attached to or detached from the vehicle.

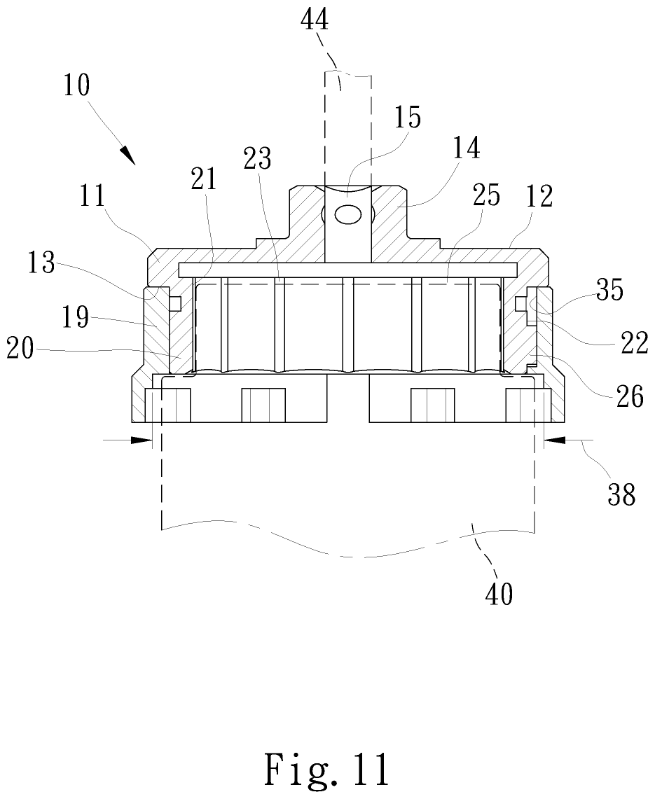

Referring to FIG. 11, in operation, the oil filter-used apparatus 10 receives an oil filter 40. A non-circular end (not numbered) of a screwdriver or an Allen key 44 is located in the non-circular bore 15. Thus, the Allen key 44 and the oil filter-used apparatus 10 are used together to rotate the oil filter 40.

The collar 18 includes an internal diameter 37 (FIG. 5) smaller than an internal diameter 38 (FIG. 11) of the collar 19. Preferably, the collar 18 includes an external diameter smaller than an external diameter of the collar 19.

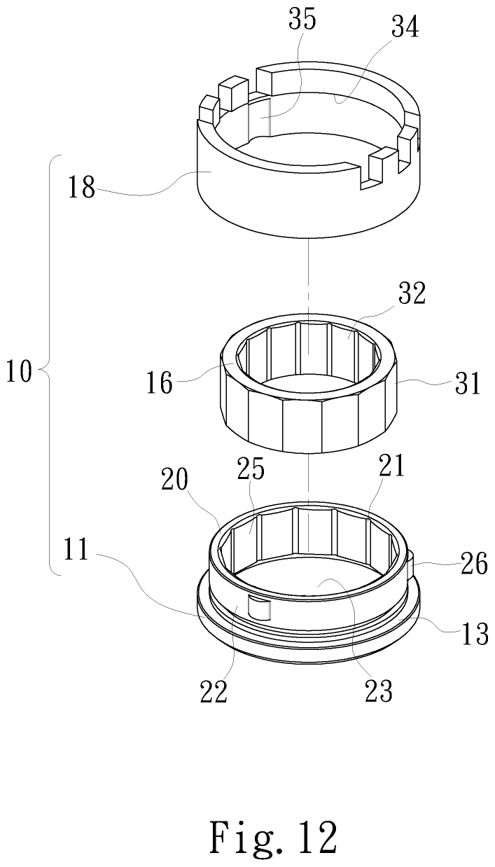

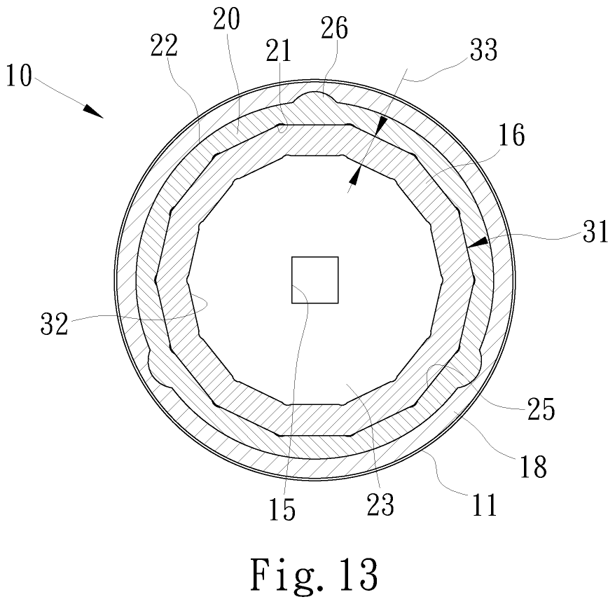

Referring to FIGS. 12 and 13, according to a fourth embodiment of the present invention, the oil filter-used apparatus 10 includes at least one lining 16 instead of the collar 19.

The lining 16 is an annular element formed with facets 31 on an external side and facets 32 on an internal side. Each of the facets 31 is located in located a radius with a corresponding one of the facets 32. Therefore, the lining 16 is formed with a constant thickness 33.

In operation, the lining 16 is located in the annular wall 20 so that the facets 32 are in contact with the facets 25. The lining 16 receives a smaller oil filter so that the facets 31 are in contact facets (not numbered) of the smaller oil filter. Thus, the oil filter-used apparatus 10 is operable to rotate the smaller oil filter.

The oil filter-used apparatus 10 exhibits several advantages. Firstly, it is operable to rotate oil filter 40 in various sizes.

Secondly, it is compact and lighter for the cover 11 is made separately from the collars 18 and 19 and the lining 16.

Thirdly, it is inexpensive because the cover 11 is made separately from the collars 18 and 19 and the lining 16.

The present invention has been described via the illustration of the embodiments. Those skilled in the art can derive variations from the embodiments without departing from the scope of the present invention. Therefore, the embodiments shall not limit the scope of the present invention defined in the claims.

1. An oil filter-used apparatus comprising:
a cover for engagement with an external torque tool, wherein the cover comprises an annular wall; and
multiple collars for engagement with oil filter in different size, wherein one of the collars is selected for connecting one of the oil filters to the annular wall.

2. The oil filter-used apparatus according to claim 1, wherein the annular wall is inserted in the selected collar in operation.

3. The oil filter-used apparatus according to claim 1, wherein the annular wall comprises at least one boss, wherein each of the collars comprises at least one recess for receiving the at least one boss.

4. The oil filter-used apparatus according to claim 1, wherein each of the collars comprises at least one boss, wherein the annular wall comprises at least one recess for receiving the at least one bosses.

5. The oil filter-used apparatus according to claim 1, wherein each of the collars comprises at least one boss, wherein the annular wall comprises at least one L-shaped groove for receiving the at least one boss.
